(19) United States
(12) Patent Application Publication
(10) Pub. No.: US 2010/0140369 A1
(43) Pub. Date: Jun. 10, 2010

(54) PRECISION LIQUID APPLICATOR

(76) Inventors: Joseph Stanley Siernos, Greensboro, NC (US); John R. Devecka, Budd Lake, NJ (US)

Correspondence Address: LAWRENCE EDELMAN, ESQ, 3 BUFFALO RUN, EAST BRUNSWICK, NJ, 08816, US

(21) Appl. No.: 12/631,806

(22) Filed: Dec. 4, 2009

Related U.S. Application Data
(63) Continuation of application No. 11/226,697, filed on Sep. 14, 2005.
(60) Provisional application No. 60/609,994, filed on Sep. 14, 2004.
(60) Provisional application No. 60/660,194, filed on Mar. 10, 2005.

(51) Int. Cl. B05B 17/00

(52) U.S. Cl. 239/1

(57) ABSTRACT

An applicator for providing a cost effective and simple method of edging lawns and precisely applying liquids to narrow areas. The applicator includes a frame having at one end a handle adapted to be pushed by the hand of a user, and at opposite end a wheel rotatably attached to the frame. A reservoir is attached to the frame intermediate the handle and the wheel, for storing a volume of fluid therein. The reservoir having an orifice therein positioned in juxtaposition to the wheel from which the liquid stored in the reservoir is allowed to flow toward a nozzle or to land the outer surface of the wheel. The reservoir preferably comprises a user replaceable sealed container having a self-piercing end for allowing a safe refill of the applicator with chemicals that may be hazardous. In an alternative embodiment, a commercially available tank/pump and spray wand is adaptable to the rolling applicator of the invention.

### CROSS-REFERENCE TO RELATED APPLICATIONS

This application is a continuation of and claims priority under 35 USC 120 of U.S. patent application U.S. Ser. No. 11/226,697, filed Apr. 29, 2006, which application claims priority under 35 USC 120 of two prior U.S. Provisional Patent Applications: U.S. Ser. No. 60/609,994, filed Sep. 14, 2004, and U.S. Ser. No. 60/660,194 filed Mar. 10, 2005. The entire disclosure of all of these patent applications is incorporated herein by reference in their entirety.

### BACKGROUND OF THE INVENTION

1. Field of the Invention

The present invention relates to manually operated liquid applicators, particularly useful for precision application of herbicide type chemicals for edging lawns and similar uses.

2. Background Information and Description of the Related Art

Liquid applicators, such as for chemicals, herbicides and paints, for example, have been in use for years. Typically, a liquid applicator is comprised of a storage reservoir for storing the liquid, a pump attached to the storage reservoir for either applying air pressure into the storage reservoir or for drawing the liquid from within, and a nozzle attached to the storage reservoir by a length of hose for dispersing the liquid.

Conventional liquid applicators are fine for the duties they are designed—spraying broad areas of vegetation. However, conventional liquid applicators are not suitable for precisely applying a liquid to a narrow and defined area so as to prevent damaging or killing surrounding vegetation. Additionally, conventional sprayer devices are somewhat undesirable for ordinary consumer use in that they create a mist of the chemical that the homeowner may inhale or which the wind may blow onto lower extremities of the homeowner, which can be unhealthy for the homeowner over extended periods of time.

Examples of attempted liquid chemical applicators include U.S. Pat. No. 3,158,892 issued to Bridger et al, which has a rolling wheel at end of an elongate handle, which sprays the liquid onto a hood that surrounds the front of the wheel, and the liquid then drips off the hood onto the area to be treated. U.S. Pat. No. 3,357,646 issued to Meyer shows a tractor pulled frame having two spaced apart wheels for allowing the frame to be pulled over an area to be treated, and a sprayer nozzle is mounted adjacent the axel in one of the wheels so as to spray the liquid on the ground in the space between the two wheels. These devices are somewhat undesirable as consumer items in that they have very limited uses.

Laughlin (U.S. Pat. No. 2,951,314) discloses a consumer-type handle based spraying device. More specifically, Laughlin teaches a handle carrying a replaceable tank of liquid having an outlet for supplying the liquid contents to a felt disc mounted at an end of the handle adapted to be rolled along an area to be treated with the liquid. The rolling is accomplished by a rotatable cutting blade adjacent to the felt disc. Thus, although this device provides multiple ways of removing/killing vegetation, the device has very limited application due to the way it applies the liquid herbicide.

Fields, II (U.S. Pat. No. 6,295,757) discloses a handle having one end adapted to be pushed by a user, and another end having a rotating wheel which allows the user to push the device over an area to be treated. A portion of the handle intermediate the two ends holds a liquid storing tank adapted to supply a liquid herbicide to an interior chamber of the wheel, where the liquid is allowed to flow out to the surface of the wheel. The wheel surface includes an absorbent material which becomes saturated with the herbicide, and as the wheel is rolled over and area to be treated, the weight of the device causes the absorbent material on the wheel to be squeezed, thereby causing the herbicide to be deposited along the route followed by the wheel. Although this device also includes a hand held spraying wand, its use would be rather difficult, since after using the “wheel” applicator, one must lift the device off the ground and carry it around wherever one wants to use the sprayer, in order to prevent the saturated wheel from doing unwanted application of herbicide as the sprayer is being moved from one location to another during its operation. The saturated wheel is also dangerous to the user, in that the absorbent material can be easily contacted by the user while the user is carrying the device from place to place in order to use the sprayer. The applicator roller cannot apply liquid into cracks for preventative application. It can only roll on the surface of a crack. For cracks it is also desirable to have a precision spray application, and such a spray wand is difficult to use to spray into cracks accurately. The roller can get dirty and clogged especially if the edge contains loose dirt or grass giving an inconsistent application.

While these devices may be suitable for the particular purpose to which they address, they are not as suitable for providing a cost effective and simple method for simultaneously meeting the requirements of multiple precision applications, such as would be useful for a homeowner having several different types of lawn and sidewalk edging requirements, as well as the need for applying chemicals to narrow areas, such as cracks and crevasses. Conventional sprayer devices do not allow for spraying within narrow areas without damaging surrounding vegetation, and although wheel devices such as shown by Fields, II can apply chemicals without spraying, unless the entire bulky spraying device is hand carried by the homeowner, the chemical saturated wheel can cause unwanted application of herbicide when it is desired to use only the hand sprayer.

It would be desirable for the homeowner to be able to also make preventative applications, such as by spraying, deep into cracks and crevices. It would also be desirable that such a device have the precision application benefits of a roller type applicator such as shown by Fields II, but without the need that the device be picked up and carried over grass or other areas where chemical application is not desired. I would also be desirable to not have to clean or rinse off such a chemical applicator roller, and to provide a roller type applicator that doesn't present a danger of a chemically soaked wheel that is stored in the garage of the homeowner. Finally, it would be desirable to provide a roller type applicator that has a long lasting wheel.

In these respects, the chemical application system according to the present invention substantially departs from the conventional concepts and designs of the prior art, and in so doing provides an apparatus primarily developed for the purpose of providing the homeowner a cost effective and simple apparatus for precision application of chemicals to both narrow and recessed areas.

### SUMMARY OF THE INVENTION

In a first embodiment of the present invention, a liquid applicator particularly adapted for homeowner use for precisely applying liquids such as herbicides or other chemicals, includes the following:
a frame member having one end adapted to serve as a handle for a user of the applicator, said one end including an adapter for selectively being connected to an output end of a commercially available spray head which has an input end connected by a hose to a tank of liquid to be applied by said applicator; and
a wheel mounted at an opposing end of the frame member, said wheel comprising at least two rotatable and adjustably spaced apart discs, having a spray nozzle mounted in between said discs,
whereby a trigger is provided for the user to control starting and stopping of a flow of said liquid from said spray head to said spray nozzle mounted in between said discs.
   In one embodiment the trigger is provided as part of the commercially available spray head, and in another embodiment, the trigger is provided as part of the handle.

In a second embodiment of the present invention, a chemical sprayer particularly adapted for homeowner use for precisely applying chemicals such as herbicides, includes the following:
a frame member having one end adapted to serve as a handle for a user of the applicator;
a wheel mounted at an opposing end of the frame member, said wheel comprising at least two rotatable and adjustably spaced apart discs, having a spray nozzle mounted in between said discs, and
a replaceable tank of liquid to be applied by said applicator, said frame being adapted receive said tank in a manner so that a seal that prevents said liquid from leaving said tank is automatically opened so as to enable the liquid in the tank to begin a fluid communication towards said nozzle.

### BRIEF DESCRIPTION OF THE DRAWINGS

The accompanying drawings, which are incorporated herein and constitute part of this specification, illustrate embodiments and details of the invention, and, together with the general description given above and the detailed description given below, serve to explain the features of the invention.

FIG. 1 illustrates a side view of a liquid applicator which adapts to a commercially available liquid tank having a spray head connected thereto via a hose, constructed and operating in accordance with the principles of the present invention,

FIG. 1A illustrates a front view of a liquid applicator of FIG. 1,

FIG. 2 illustrates a side view of a liquid applicator having a replaceable proprietary liquid holding tank, constructed and operating in accordance with further principles of the present invention,

FIG. 2A illustrates a front view of a liquid applicator of FIG. 2,

FIG. 3 illustrates a side view of a liquid applicator somewhat similar to FIG. 1, but wherein the liquid reservoir is formed in the handle, and

FIG. 4 illustrates a side view of a liquid applicator somewhat similar to FIG. 3, but having a replaceable liquid reservoir.

### DETAILED DESCRIPTION OF THE INVENTION

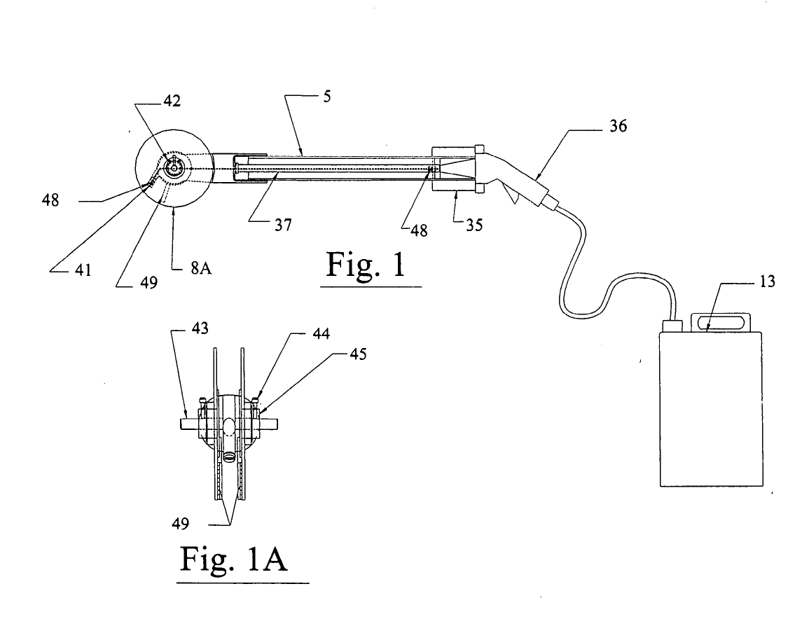

As shown in FIG. 1, a liquid applicator particularly adapted for homeowner use for precisely applying liquids such as herbicides or other chemicals, includes a frame member 5 having at one end a wheel arrangement 8a, and at an opposed end an adapter 35. FIG. 1A illustrates a front view of wheel arrangement 8a, which comprises two rotatable spaced-apart discs mounted on an axle 43 using bushings 45. Set screws 44 are used to lock the discs 8a at a desired spaced-apart position on axle 43, such as from ⅕th of an inch to several inches apart, and retaining snap rings 42 may also be used to hold the discs 8a on the bushings 45 on shaft 43 in a conventional manner.

A spray nozzle 41 is mounted on the axle so as to spray the liquid onto the ground between the spaced apart discs 8a, as the user rolls the applicator over a desired area. Thus, the user adjustable spacing between the discs 8a precisely controls the area over which the liquid is applied as the user simply rolls the applicator over the desired area. By placing the nozzle 41 between the two spaced apart discs of wheel 8a, there is little chance that any portion of the liquid spray will find its way onto the consumer/operator of the applicator, due to such things as blow-back caused by wind, etc. Additionally, an inside surface of the discs 8a may have wipers 49 mounted nearby, to deflect any accrued liquid from accumulating and dripping.

A particularly useful aspect of the liquid applicator of the invention is that it is adapted for use in conjunction with a commercially available liquid tank 13 which is connected by a hose 113 to a spray handle 36. The adapter 35 is designed so as to selectively connect to and accept the spray handle 36, so that the liquid spray provided thereby can be conducted by a tube 37 which passes from the adapter 35 to the nozzle 41 located between wheel discs 8a. A trigger 136 on spray handle 36 allows the user to control starting and stopping of the flow of the liquid from said spray handle 36 to the spray nozzle 41 at the wheels 8a. Thus, the present invention provides a useful add-on device for use with commercially available spray containers. The tank 13 may include a hand operated piston pump, not shown, if desired. When the rolling applicator is not needed, the spray head 36 can be disconnected from the rolling liquid applicator, and spray head and tank 13 can used separately, as desired.

In an alternative embodiment, the spray handle 36 and trigger 136 may be provided as part of the handle 36 of the liquid applicator, and a fitting 137 at an end of the hose 113 remote from the tank 13 can be directly attached to a spray handle 36 which is built into frame 5, for example by the use of screw threads, when it is desired to use the precision liquid applicator of the present invention.

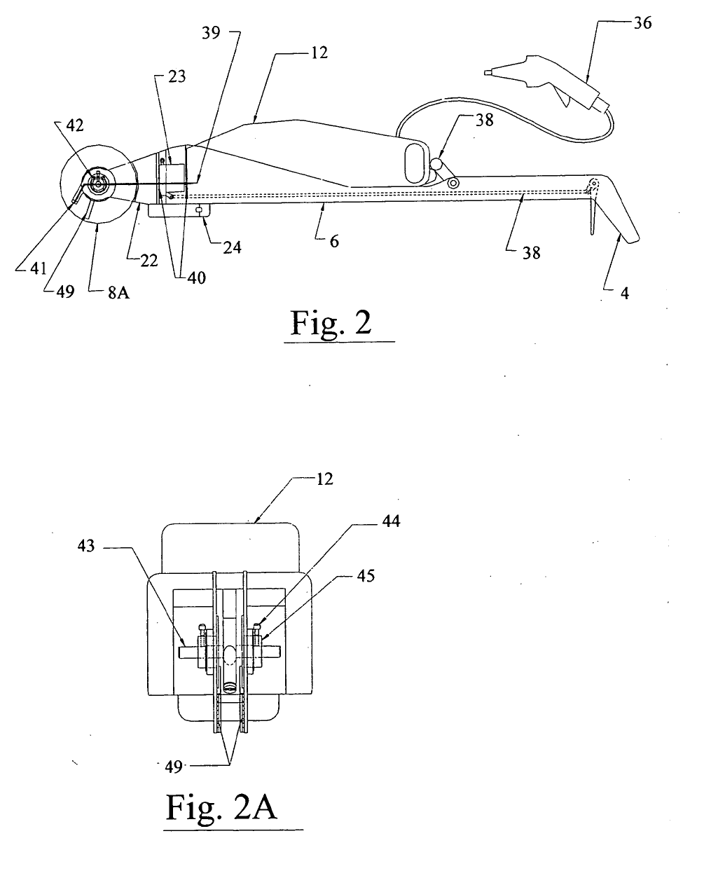

FIGS. 2 and 2A illustrate a side and front view, respectively, of a liquid applicator having a replaceable, non-refillable, proprietary shaped, liquid holding tank 12, constructed and operating in accordance with further principles of the present invention. A frame member 6 basically comprises a holder for the tank/reservoir 12, where one end of the frame 6 is adapted to serve as a handle 4 for a user of the applicator, and at an opposed end of the frame 6 a bracket 22 is used to facilitate attachment of a wheel assembly 8a, which is substantially the same as wheel assemble 8a of FIGS. 1 and 1A. The replaceable tank 12 includes, for example, a seal 40 of conventional design (such as a self-sealing rubber), and the frame 6 includes a hollow piercing needle 39, which pierces seal 40 when tank 12 is inserted into an operating position on frame 6 and then locked in place using lock mechanism 32. Alternatively, the removable tank 12 inserts into valve which opens when tank 12 is inserted and allows the liquid flow, via a tube, to a drip or spray nozzle 16. A spring can be included in the valve so as to ensure it closes in the event that the tank 12 is removed.

A DC pump 23 powered by a DC battery pack 24 may be used to assist the flow of the liquid in tank 12 to the spray nozzle 41. A user operable trigger 136 in handle 4 is connected via a linkage 38 to operate the pump 23. Alternatively, a friction driven pump, not shown, driven by rotation of wheel 8a, could be used to assist the flow of the liquid, or perhaps, in some applications, no pump at all may be needed, and instead gravity alone may be sufficient to allow flow of the liquid to nozzle 41. Such a replaceable tank is a particularly safe way for consumers to handle liquids that are potentially dangerous to their health, since they never have to refill, open or close the containers, thus minimizing the consumer to exposure of the liquids being dispensed. Additionally, as noted above, the two spaced apart discs protect the consumer/operator from unwanted exposure to the liquid due to such things as blow-back caused by wind, etc, during use of the applicator.

For improving the flexibility/use of the applicator, an auxiliary hand held sprayer head 36 is connected by a hose to either tank 12 or the output port of pump 23, for allowing the user to directly and accurately spray the liquid onto spots (and other areas of concern, which areas are not easily accessible by use of the nozzle 41 of the rolling wheel applicator) and for preventative spraying of larger areas, whereby during use of the spray wand, the wheel only provides easy rolling transport of the liquid applicator device.

Referring in general to any of the above described embodiments, the applicator device can have an ergonomically designed grip handle, which can have foam grips and can have an adjustability which will allow for height adjustments.

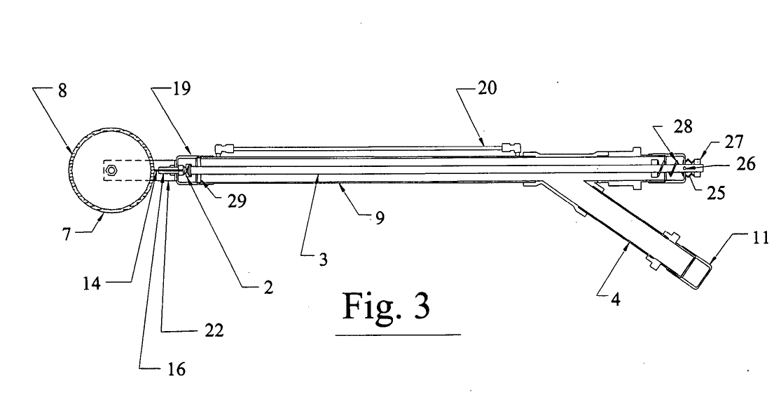

FIG. 3 illustrates an alternative embodiment, where the frame member is hollow so as to also serve as a container 9 to hold any type of liquid, such as a paint, foam or herbicide to be applied by the applicator (such other types of liquids can also be used in the foregoing embodiments). The handle or body 4 has a cap 11, with an opening to allow the user to manually fill the herbicide by pouring it in, as well as a vent, comprising vent 25, lift retaining pin 26, retaining collar 27 and valve pressure spring 28, if such a vent is required or desired. The lift retaining pin 26 can also control the flow of the liquid 14 to a nozzle 16 via a linkage 3. A sight, such as a rod or tube 20 mounted along a top portion of the applicator from the handle portion 4 towards the wheel 8, can also be used to assist precision application of the liquid.

Although wheel 8 may comprise the same type spaced-apart wheels 8a of the above described embodiments, a more conventional design for the wheel could be used, and the surface of the wheel 8 can include a detachable/replaceable felt 7, or other type of surface to which the liquid can be sprayed or dripped by a nozzle 16 directly thereupon, for application to the desired area by directly rolling the wheel including the liquid saturated felt, thereover. When/if the felt gets dirty or worn, it can be replaced. A dirt removing brush/lap 18, or similar means can be included, if desired, to scrape and remove objects that stick to the roller, making the unit self-cleaning. A protective and removable cover can be used for the unit or for the roller apparatus for storage after use.

These items relating to the liquid absorbable wheel can be sold separately, or entire new wheels can be sold. Wheel 8 can be removed and replaced with a foam pad or other type of pad capable of precisely delivering the required solution(s) to singular grass/weed areas. The wheels or surface of the wheels can be made of an absorbable material 7, or non-absorbable material which has, for example, dimples or other surface irregularities molded into a plastic wheel, that temporarily hold the liquid until it is applied during the rolling motion of the wheel. Larger diameter wheels, such as 6 inches, allow easier application of solution(s), however, the wheel can be any diameter.

The use of the wheel as a media to direct the deposit of can include materials such as plastics, wood, metal, alloy, rubber, and associated rubberized compounds plasticized roller(s) as well as a strip sled guided applicator can be added to facilitate special conditions. The outer surface of the wheel can be covered with felt, foam or other material to function as the absorbable material 7. Securing of the material 7 to the wheel 8 can be with the use of permanent means, or it can be temporarily held in place with Velcro or other easy to release fasteners, to ease the burden of replacement.

It should be noted that use of such an absorbable the wheel as the dispensing media could also be used in either of the FIG. 1 or FIG. 2 embodiments. The supply nozzle would feed the outside of the wheel, ensuring a clean, precise and unobstructed flow of liquid.

As an alternate use of the applicator, straight-line application is desirable to line sports fields, edge a sidewalk, or parking lots using the wheel to apply paint, dye or herbicide. The use of optical guides can be mounted on or around the apparatus to guide the user in straight-line applications. The guide can include a laser to project a beam onto the areas where the solution is to be applied. Chalk, paint or lime can be used to dispense either as a main marker or used in conjunction with herbicide to line grass areas.

The applicator can be fitted with a wheel capable of measuring linear or curved distances, each revolution of the wheel can record distance rolled by user (i.e. 1 revolution is equivalent to 12 inches) counter on or driven by wheel reads proportional distances.

In accordance with a different embodiment of the invention, the wheel or wheels are used only a guide and the herbicide which is dripped on a stationary 1″ surface, which can be felt pad or plastic/flexible rubber flap or pad which rubs on edge. The flap can be adjusted. The wheel can be used to generate pressure which is supplied to the container to force low viscosity solutions onto the media surface(s).

In a further alternative embodiment, the wheel 8 itself can be hollow, filled with herbicide and have ported Ventura to distribute solution(s) to the outer surface of a porous wheel.

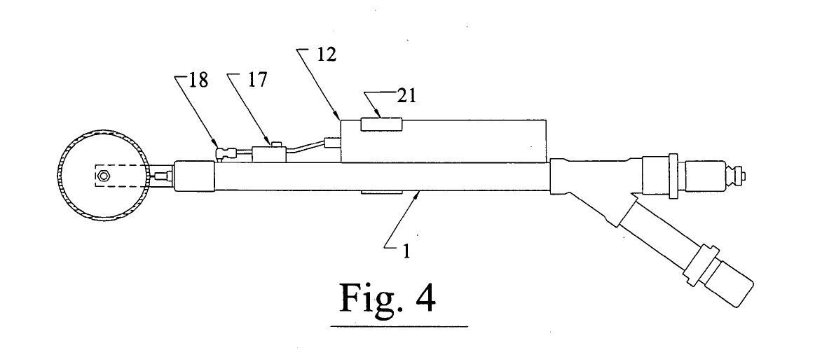

FIG. 4 illustrates a further alternative embodiment where the frame 1, can contain a clamping apparatus 21, which will secure an alternative type of container 12 thereto. A user operated slide control valve/shut off 17 controls the flow of the liquid from a hose connected between the container 12 and an exit fitting 18 which is connected to the applicator and then nozzle. The user can also carry the container 12 in their hand or attach it to their person and be connected by a tube to the roller applicator device 1. The applicator can have a rolling wheel applicator as shown in any of the above-described embodiments.

In general, the above applicator devices will have a control valve, or control system to control the flow rate of herbicide or other solution(s) 14. The controls can be made in a variety a ways. Orifice(s) can regulate the flow and/or porting either singular or via multi-port by rotary or pop it valve control(s). Controls can be localized or linked, associated either internally or externally, operation of which would be manually lifting or turning the control link (such as shown by link 3 and pin 26 of FIG. 3), which in turn opens and closes port(s) to allow flow of solution(s) to nozzle(s) 16, or multi-ventura manifold. Venting is desirable where gravity feed is used, and porting is with either manual lift/turning at control link, lifting/turning port openings on manufactured containers, or by mechanical interlink through the control rod(s) 3. Control of the flow rate of the solution(s) can be regulated through port orifice size change, or by multi-port orifice selection, either by manual or automatic operation of the control(s). The size of the orifice change would be coordinated with the rate of speed at which the user can apply the solution(s), for example, rotation of the wheel 8 can operate a cam or faceted link by which revolution of wheel 8 operates orifice and/or controls the opening size or Ventura selection. Rotation of wheel 8 drives a tubing pump to apply solution to wheel 8, or, for example, to the auxiliary spray wand 36 of the type shown in FIG. 1, when the wheel is used only as a guide for rolling. Wheel 8 can be used to drive liquid displacement or an air pump so as to regulate orifice control. Wheel 8 can drive pump to apply pressure to container 12 to facilitate a positive feed of the solution(s). Wheel 8 can also be used to drive an encoder so as to signal a desired orifice selection and/or opening size. Many other known pumping means are also possible.

A special container 12 can be designed to make it difficult to be refilled or reused by the consumer (for his own safety in the event that the liquids may be hazardous to health), and the container can also have an air valve to allow more rapid and consistent flow or other means can be used. In an alternative embodiment, the separate container 12 can be designed to easily allow refilling.

Use of a bi-cavity (dual) reservoirs 9 or 12, can mix at the valve/exit/nozzle to actuate solutions at point of contact. Alternatively, a bi-cavity reservoir can hold two different solutions whereby only one at a time can be opened for use. These dual cavities can contain, for example, two different herbicides.

The above described container designs can include injection or blow molded plastics, all designs being capable of incorporating handles and porting areas for dispensing all substances. Metal cylinder(s) with the capacity to be pressurized, soft plasticized bags or combinations of aluminum foil/vinyl containers with orifice, capable of feeding liquids can be used.

The drip and spray valve/nozzle, may have adjustments made locally or remotely from the handle, the amount of the liquid solution(s) released is adjusted to a proper amount required to help kill the weeds, and varies based on walking speed. A self-regulating, self-speed adjusting rate of flow can be achieved by a variety of means.

While the present invention has been disclosed with reference to certain embodiments, numerous modifications, alterations and changes to the described embodiments are possible without departing from the sphere and scope of the present invention, as defined above, and in the following claims. Accordingly, it is intended that the present invention not be limited to the described embodiments, but that it has the full scope defined by the above language and the following claims, as well as equivalents thereof.

1. A method of precisely treating a perimeter edge of an area of vegetative growth with an application of herbicide so as to prevent vegetative growth in the perimeter edge, said method comprising:
projecting a spray of herbicide from an applicator which has a supply of said herbicide included therewith, and
rolling the applicator along the perimeter edge of said area while said applicator projects said spray onto said perimeter edge.

2. The method of claim 1, where said projecting step includes the step of allows a user of the applicator to set a width for said spray.

3. The method of claim 2, where said user sets the width of said spray by adjusting a spray nozzle on said applicator.

4. The method of claim 2, where said user sets the width of said spray by adjusting spacing between parallel, spaced-apart discs.

5. The method of claim 3, where said user sets the width of said spray by adjusting spacing between parallel, spaced-apart wheels which are used by said user to roll said applicator along the perimeter edge.

6. A method of precisely treating a strip-like area, which strip-like area has one of a plurality of possible widths and is susceptible to vegetative growth, with an application of herbicide so as to prevent vegetative growth only in the strip-like area, said method comprising:
projecting a spray of herbicide from an applicator which has a supply of said herbicide included therewith, and
rolling the applicator over said strip-like area while said applicator projects said spray onto said strip-like area.

7. The method of claim 6, where said projecting step includes the step of allows a user of the applicator to set a width for said spray.

8. The method of claim 7, where said user sets the width of said spray by adjusting a spray nozzle on said applicator.

9. The method of claim 7, where said user sets the width of said spray by adjusting spacing between parallel, spaced-apart discs.

10. The method of claim 7, where said user sets the width of said spray by adjusting spacing between parallel, spaced-apart wheels which are used by said user to roll said applicator along the strip-like area.
